(19) United States
(12) Patent Application Publication
(10) Pub. No.: US 2006/0205362 A1
(43) Pub. Date: Sep. 14, 2006

(54) Audio signal transmitting apparatus

(75) Inventors: Chi-Tung Chang, Taipei City (TW); Ant Lan, Taipei County (TW); Shih-Hsieng Yang, Taipei County (TW)

Correspondence Address: Chi-Tung Chang, 9F., No. 37, Dongsing Road, Xinyi District, Taipei City, 110, TW

(73) Assignee: Alcor Micro, Corp.

(21) Appl. No.: 11/077,679

(22) Filed: Mar. 14, 2005

(51) Int. Cl. H04B 1/46

(52) U.S. Cl. 455/79

(57) ABSTRACT

An audio signal transmitting apparatus utilizes an encoder/decoder and an audio signal controller to convert an audio signal received by a mobile phone into a file executable by a computer system, and also can convert an audio message of the computer system into an audio signal transmissible by the mobile phone. The invention includes an encoder/decoder, an audio signal controller coupled to the encoder/decoder, and a plurality of audio transmission interfaces respectively coupled with the encoder/decoder and the audio signal controller.

### FIELD OF THE INVENTION

The present invention relates to an audio signal transmitting apparatus, and more particularly to an audio signal transmitting apparatus that utilizes an encoder/decoder and an audio signal controller to convert an audio signal received by a mobile phone into a file executable by a computer system and also convert an audio message of the computer system into an audio signal transmittable by the mobile phone.

### BACKGROUND OF THE INVENTION

As mobile phones become popular and the mobile communication service industry brings tremendous convenience to people, the new functions of a new generation mobile phone not only limits the basic transmission of telephone voices, but also integrates the transmission and receipt of images. Therefore, telecommunication companies of the mobile service industry further provide other transmissions functions such as short messages and image transmission, and the storage service for leaving messages when both of the sending and receiving parties of phone users cannot contact with each other instantly.

At present, the main storage services provided by telecommunication companies include a voice mail service and a short message storage service. The services record and store a sender's messages or short messages, and then a receiver can listen to the message or read the short message any time. However, the service requires the receiver to dial a special number to listen to the message, and thus costs an additional telephone fee, and the service is applicable for replying a mobile phone call or sending short messages only. As to short message senders who need to send a large quantity of textual contents, the operation for pressing keys is too laborious.

In view of the shortcomings of the prior art voice mail service having a limited applicability for audio signals only and requiring an additional cost for receiving messages, the inventor of the present invention conducted research and development to overcome the shortcomings of the prior art.

### SUMMARY OF THE INVENTION

The primary objective of the present invention is to apply the invention to send audio signals received by a mobile phone to a computer system for storage and achieve the function of listening to the voice message, so that a user needs not to pay an additional telephone fee to listen to the voice mail stored in the voice mail box of telecommunication companies. On the other hand, the invention is used to send a voice message produced by the computer system to a mobile phone for message transmission.

Another objective of the present invention is to set the invention to provide a function similar to a telephone secretary that can automatically filter incoming calls or automatically transfer a call according to user's setting. The function of automatically filtering incoming calls can replay unknown or unwelcome incoming calls to avoid unnecessary disturbance according to user's preset numbers. The function of automatically transferring calls can send a message to a receiver's email address or specified telephone number automatically according to a user's preset email address or telephone number, so that the user at a remote end can read the latest message at once.

The audio signal transmitting apparatus in accordance with the present invention comprises: an encoder/decoder; an audio signal controller coupled to said encoder/decoder; and a plurality of audio transmitting interfaces coupled to said encoder/decoder and said audio signal controller respectively.

To make it easier for our examiner to understand the objective of the invention, its innovative features and performance, a detailed description and technical characteristics of the present invention are described together with the drawings as follows.

### BRIEF DESCRIPTION OF THE DRAWINGS

FIG. 1 is a schematic view of the structure of an audio signal transmitting apparatus of the present invention.

### DETAILED DESCRIPTION OF THE PREFERRED EMBODIMENTS

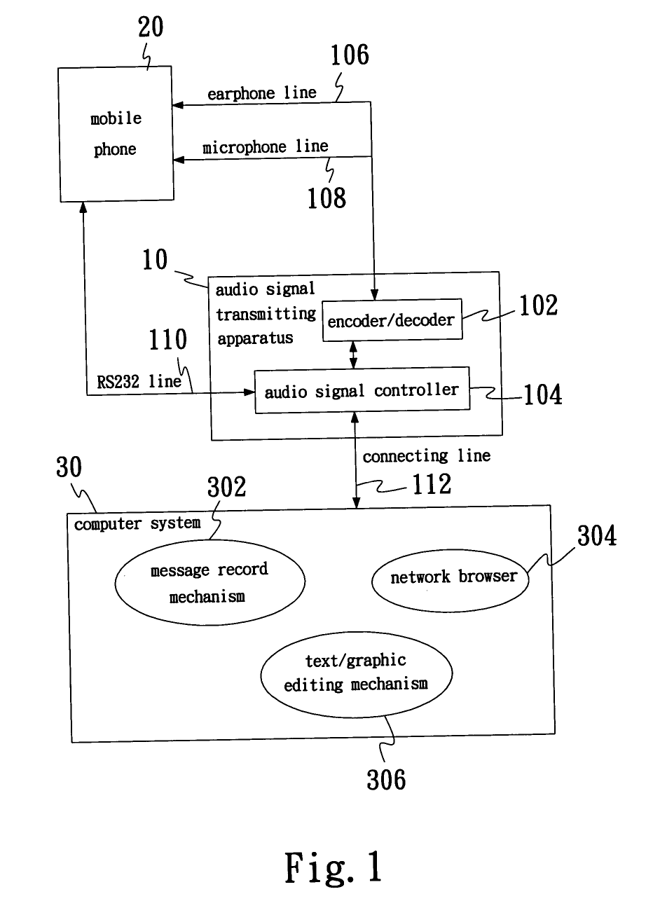

Referring to FIG. 1, a schematic view of the structure of an audio signal transmitting apparatus of the present invention is shown. In FIG. 1, an audio signal transmitting apparatus 10 comprises an encoder/decoder 102, an audio signal controller 104, and a plurality of audio transmitting interfaces; wherein the encoder/decoder 102 can convert an analog signal into a digital signal and vice versa, and the voice signal controller 104 converts a decoded audio packet into an audio file executable by a computer system. An audio signal transmitting apparatus 10 uses a plurality of audio transmitting interfaces such as an earphone cable 106, a microphone cable 108 and a RS232 cable 110 to connect a mobile phone 20 with the encoder/decoder 102 and the audio signal controller 104. On the other hand, the audio voice transmitting apparatus 10 is coupled to a computer system 30 by a cable connection such as a connecting cable 112 or a wireless connection such as an infrared connection or a Bluetooth connection. The computer system 30 could be a desktop computer (PC), a notebook computer, a personal digital assistant (PDA), or a palm computer (handheld PC), etc.

In FIG. 1, when a mobile phone 20 receives an incoming message, the mobile phone 20 will beep or remind the receiver by a reminder message to receive the incoming message. If the incoming message has not been received for a predetermined period of time, the RS232 cable 110 sends a synchronous reminder signal to the audio signal controller 104. The controller 104 will request to download a voice message packet of the mobile phone 20 and the download signal is an analog packet which will be converted into a digital packet by the encoder/decoder 102, and then the audio signal controller 104 converts the digital packet into a file executable by the computer system 30, and the file is saved into a message recording mechanism 302 of the computer system through the connecting cable 302. In this embodiment, the present computer system 30 obtains the message left in the voice mail box, and thus achieving the function of sending and receiving voice mails and using the voice mail box.

On the other hand, the present invention can transmit an audio/video signal received by a mobile phone 20, which refers to the mobile phone 20 downloading the audio/video signal from the Internet by a wireless transmission, and the audio/video signal is transmitted to the encoder/decoder 102 through the earphone cable 106 and the RS232 cable 110 and converted into a digital packet signal. Then, the video signal controller 104 converts the digital packet signal into a file executable by the computer system 30. The file is sent and saved into a message record mechanism 302 through a connecting cable 112. Further, the present invention can send the voice message stored in the computer system 30 to a mobile phone 20 through the audio signal transmitting apparatus 10 for its transmission. The technical measures use a network browser 304 existed in the present computer system to browse messages on the network, and such message is edited to generate an audio file by using a text/graphic editing mechanism 306, and the audio file is sent to the present invention through a connecting cable 112, an infrared connection, or a Bluetooth connection. The audio signal controller 104 converts the file into digital packet signals, and such signals are converted into analog packet signals by the encoder/decoder 102 and uploaded to the mobile phone 20 through the RS232 cable 110 and the microphone cable 108, and then transmitted to a receiver by the mobile phone 20. For example, the audio file executable by the audio signal transmitting apparatus 10 can be sent to a receiver's email address via an email.

In summation of the description above, the present invention has the following advantages. The invention just requires a user to open a file at the computer 30 end and listen or browse message by application software such as an audio/video player and a browser without costing additional fees or the requirement for dialing a special telephone number to listen to messages. On the other hand, the application of the invention allows users to set the functions of automatically filtering incoming calls, automatically transferring calls, and the function similar to the telephone secretary. Therefore, the present invention complies with patent application requirements including novelty, advancement and usefulness, and is submitted to the Patent and Trademark Office for review and granting of the commensurate patent rights.

What is claimed is:

1. An audio signal transmitting apparatus, comprising:
an encoder/decoder;
an audio signal controller, coupled with said encoder/decoder; and
a plurality of audio transmitting interfaces, coupled with said encoder/decoder and said audio signal controller respectively.

2. The audio signal transmitting apparatus of claim 1, wherein said encoder/decoder is capable of converting an analog signal into a digital signal and converting a digital signal into an analog signal.

3. The audio signal transmitting apparatus of claim 1, wherein said audio signal transmitting apparatus is set to automatically filter incoming calls and automatically transfer calls.

4. The audio signal transmitting apparatus of claim 1, wherein said plurality audio transmitting interfaces is either cabled or wireless.

5. The audio signal transmitting apparatus of claim 1, wherein said plurality of audio transmitting interfaces couple to said audio signal transmitting apparatus with a mobile phone and a computer system.

6. The audio signal transmitting apparatus of claim 1, wherein said audio signal transmitting apparatus has an executable audio file to be sent to an email address of a receiver via an email.

7. The audio signal transmitting apparatus of claim 1, wherein said computer system is one selected from the collection of a desktop computer, a notebook computer, a personal digital assistant, and a handheld computer.
